(19) United States
(12) Patent Application Publication
(10) Pub. No.: US 2017/0262795 A1
(43) Pub. Date: Sep. 14, 2017

(54) IMAGE IN-STOCK CHECKER

(71) Applicant: Wal-Mart Stores, Inc., Bentonville, AR (US)

(72) Inventors: Satya Kiran Thapa, Bentonville, AR (US); William Ross Allen, Pea Ridge, AR (US); Richard M. Blair, II, Bentonville, AR (US)

(21) Appl. No.: 15/448,648

(22) Filed: Mar. 3, 2017

Related U.S. Application Data
(60) Provisional application No. 62/305,119, filed on Mar. 8, 2016.

(51) Int. Cl. G06Q 10/08

(52) U.S. Cl. CPC G06Q 10/087

(57) ABSTRACT

A system that is primarily designed to help customers find products in a store is described. It supplements existing systems that provide a shelf location for a requested product. The current system employs high resolution cameras, such as the security cameras, and creates an image database indexed by product location. A customer uses software on a phone or home computer to interface with a server of the system. Once a product is selected, the server finds the product location for the selected product, then also retrieves the image corresponding to the product location and provides these to the customer to visually determine if there are any of these products at their product location on the shelf at the time of the image. Since all of the images are time stamped, the customer knows how long ago the image was taken. In an alternative embodiment, the customer can request a current image for older images.

### RELATED APPLICATION

This application claims priority to U.S. Provisional Patent Application entitled “Image In-Stock Checker,” serial number 62/305,099, filed Mar. 8, 2016, the disclosure of which is hereby incorporated entirely herein by reference.

### FIELD

Aspects of the present invention relate to a system for visually identifying the location of a desired product, and more specifically for a system for visually identifying a product location of a desired product and verifying that the product is available at the product location.

### BACKGROUND

When shopping, a customer needs to know if a store sells a specific product, what is the product location in the store where the product may be found, and if there are actually any of the specific products available for sale in the store, and if so, are any of these on the shelf at the product location in the store.

In the past information was extracted from the store's inventory systems to identify if the store sells a certain product, and if they sell the product, where the product is located within the store (“product location”). Inventory systems are updated with the number of each product received at the store. It is also updated with cash registers which identify the products sold and reduce the number shown as being on the shelves in inventory.

Typically, product locations are identified by aisles. Since retail stores are getting larger, these aisles typically have many shelves and may span a long distance. The customer would then go to the aisle and try to find the desired product.

Even if the customer finds the proper product location, it is possible that the item is not at its product location, even though the inventory system indicates that it should be there.

Since customers are constantly handling the products, it is possible that some are damaged. Typically, store employees (“Associates”) take damaged goods off of the shelves and put them in a holding area, where customers are not allowed. The Associate should then also update the inventory system. In some cases, the inventory system may not be updated, and continue to show a product at the product location, even though it has been taken into a holding area or discarded.

In other cases, a customer may pick up a product and put it down in a different location in the store that is not associated with this product. Even though the product is in the store and available for sale, it is not in its associated product location.

Another way in which the inventory system does not match what is available on the shelves is when products are stolen. Since these products bypass the cash register, they are not properly updated in the inventory system.

Therefore, it is possible that a customer may be notified of a product location associated with a desired product, walk to the identified product location, and find out that there are no products at this product location, causing dissatisfaction to the customer, especially if the customer has walked a long way.

This problem becomes worse if the customer is connected to the inventory system from a remote location, such as from home or the office. In this case, the customer drives from the remote location to the store and walks to the product location to find that the product is not at its associated product location.

Alternatively, a customer may call in to a store and ask the Associate if they sell a certain product, if there are any available in the store (at the proper product location). If the Associate only looks at an inventory system, it may be inaccurate for the reasons indicated above. Therefore, to provide an accurate answer to the customer, the Associate must walk to the product location and visually verify that there is a product there. This is time-consuming and takes up the Associate's time.

Currently, there is a need for an inventory system which more accurately determines if a product is available, and if so, more accurately identifies the product location, and can verify that there is actually a product available at the product location.

### BRIEF SUMMARY

According to aspects of the present inventive concepts there is provided an apparatus and method as set forth in the appended claims. Other features of the inventive concepts will be apparent from the dependent claims, and the description which follows.

In one example there is described a system for visually determining the presence of products in a retail store, which includes a product database adapted for storing information of products having an identification of a plurality of products and their associated product locations, an image database adapted for storing images of product locations and a time each image was acquired, and a number of security camera devices coupled to the image database. As is used throughout this application, the term ‘coupled to’ means ‘connected directly to’ or ‘connect to, through one or more intermediate devices’. When one or more elements are coupled to each other, they are allowed to communicate with, and pass data to each other, either directly connected, or connected through one or more intermediary devices.

The camera devices are capable of acquiring images of product locations, and storing these images, their acquisition time, and their product locations in the image database. The system also has a user's computing device adapted to interact with a user to select a product, a retailer's computing device coupled to the user's computing device, a product database, and an image database adapted to receive the selected product, find its product location in the product database, acquire the latest acquired image of the product location in the image database and send this information to the user's computing device to be presented to the user.

In one example there is described a method of visually verifying the presence of products available for sale, including the steps of interacting with a user to select a product, searching a product database to find the product location of the selected product, providing an image database having a plurality of images acquired by security camera devices of product locations time-stamped with the time each image was acquired and searching the image database to acquire the latest image of the product location of the selected product. The latest image of the product location of the selected product is then displayed to the user for visual verification that the product is in stock.

In one example there is described a system for remotely identifying product locations to be stocked having a database adapted for storing an identification of a plurality of products and their associated product locations, images of product locations each identified by their product location and time of acquisition, a number of security camera devices in the building capable of acquiring images of product locations at specific acquisition times, and storing these images, their product locations, and acquisition times in the database, a user's computing device adapted to interact with a user to select a product and a retailer's computing device coupled to the user's computing device. The database is adapted to receive the selected product, find its product location in the database, acquire the latest acquired image of the product location in the database and send this information to the user's computing device. This information is then presented to the user for visual verification that the desired product is in stock.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates an overall block diagram of one embodiment of a system in accordance with one aspect of the present invention;

FIG. 2 is a flow chart illustrating image acquisition and storage in accordance with one aspect of the present invention;

FIG. 3 is a flow chart illustrating processing of a customer request in accordance with one aspect of the present invention; and

FIG. 4 is a flow chart illustrating how an associate would interact with an embodiment of the present invention to process a customer request.

### DETAILED DESCRIPTION

At least some of the following exemplary embodiments provide an improved system and method suitable for visually identifying if a product is in stock. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

As indicated above, the customer would like to quickly and easily find a desired product and purchase the product. However, due to current systems, they receive information which is not specific enough to find the product location, and when they do find the product location, the product may not be at its product location. This causes frustration to the customer.

In other circumstances, as indicated above, the customer may call in and request that an associate indicate if a certain product is in stock (on the shelf at its intended product location). This requires the Associate to walk to the product location and visually verify if there is a product on the shelf at the product location available to be sold. Even though it may not take a long time to perform this verification, as the associate receives numerous calls, it can amount to considerable time.

The current system tries to alleviate these problems by providing a system that provides the customer a more intuitive locating system which employs visual images to supplement the product location information. If it is intuitive enough, the customers may operate the system by themselves and not have to ask an associate to direct them to the product location.

The system may also be operated from a remote location, so the user may be able to operate the present system to verify that a product is on the shelf at its intended location, available for purchase. This may be done from outside of the store, at home or other location. If more customers use the present invention, this would free up the Associate's time for other duties.

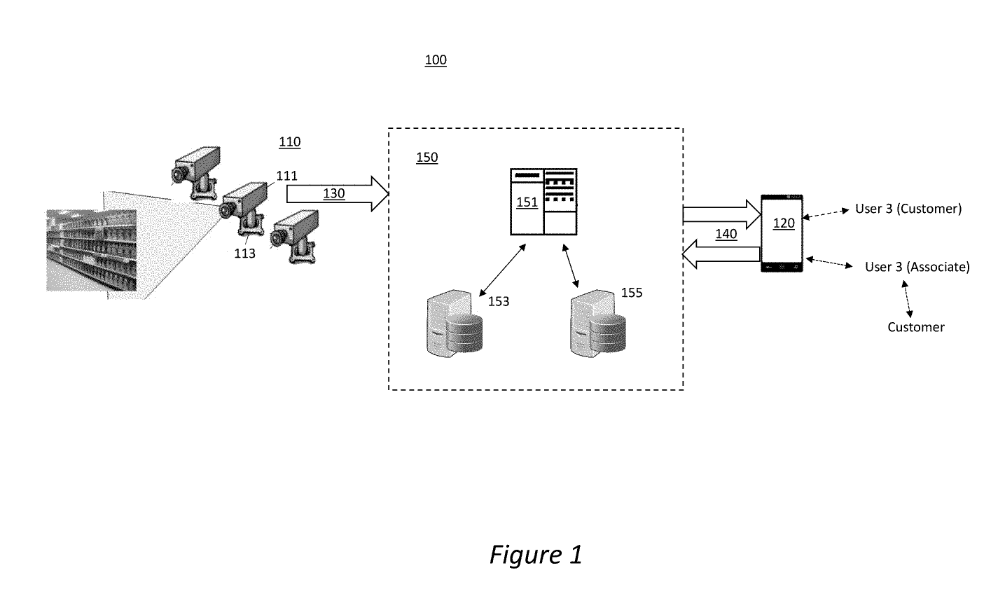

FIG. 1 illustrates an overall block diagram of one embodiment of a system in accordance with one aspect of the present invention. An image acquisition subsystem 110 includes a plurality of camera devices 111 which are capable of acquiring images of portions of a store including desired product locations on the shelves of the store. The image will be associated with one or more products and an assigned product location for the one or more products. The product locations may be the aisle, section of the aisle, subsection, or other means of defining a location within the store. It is also possible to use other locating means currently available to define the product location.

The resolution of the acquired product must be high enough for one to view the image to be able to determine which product(s) are in the image and if there is at least one product present. The images may focus in on individual product locations, may take an image of a plurality of product locations, and associate portions of the image with different product locations, or may perform post processing to ‘crop’ images into smaller images which pertain to individual products.

In still another embodiment, the system may have the ability to zoom in on an image from a wide view of several product locations to the specific product location which pertains to the desired product. This will serve both functions of showing a user the general location of where the product is located and can allow the user to zoom in to identify if any products are at the product location.

Since the number of products on the shelves changes over time, it is important to associate with each image a date and time when the image was acquired.

The image acquisition subsystem 110 employs enough cameras to cover the product locations which will be covered by the current system. This may be done by having high resolution cameras that have a wide field of view which can zoom into desired product locations, or may employ positioning devices 113 which can alter the position of the field of view for at least some of the plurality of camera devices 111 so that they can cover all of the product locations of interest. Images are sent via a camera link, being a communications link that can transfer a large amount of data, to a retailer's computing device 150. Retailer's computing device may be one or more servers, located locally, or remotely. They may be on a single device or distributed on several devices, or implemented in server pools in cloud configurations. Part, or all of the camera link 130 may employ any combination of hardwire, radio link, Wi-Fi, Bluetooth, near field or other current communication methods.

Each image is associated with the product location(s) in their field of view, and acquisition time (and date) in which each image was acquired. This information is passed through the camera link 130 to the retailer's computing device 150.

A control unit 151 in the retailer's computing device 150, receives the information over the camera link 130 and stores the information in an image database 155.

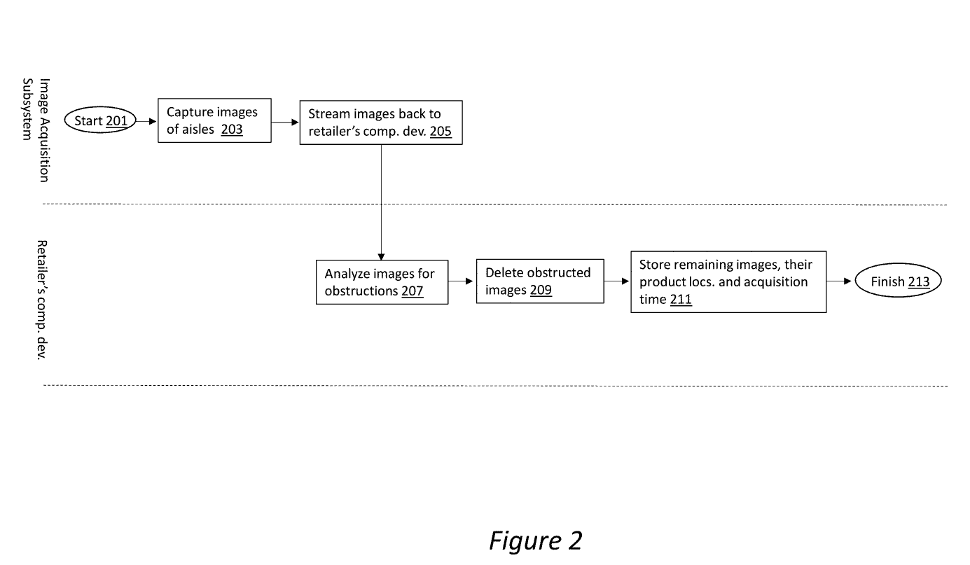

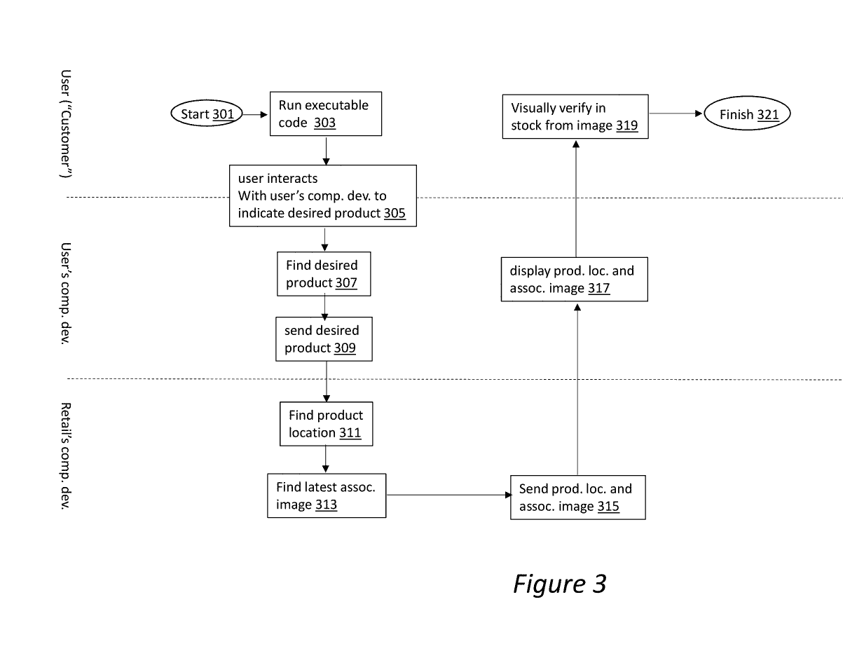

FIG. 2 is a flow chart illustrating image acquisition and storage in accordance with one aspect of the present invention. In step 201 the process starts. This embodiment of the present invention will be described in connection with both the apparatus of FIG. 1 and the flowchart of FIG. 3 indicating the structure and function of the present invention.

As indicated above, images of the aisles and product locations are acquired by the plurality of camera devices 111 of the image acquisition subsystem 110 in step 203. As indicated above, this may include capturing an image of a single product location or multiple product locations in an image.

In step 205, the image acquisition subsystem 110 streams the images, their product locations and their acquisition times over the camera link 130 to the retailer's computing device 150. The retailer's computing device 150 includes a controller 151.

In step 207, the controller 151 analyzes images from the image acquisition subsystem 110 to determine if there is an obstruction in the image preventing the desired product location(s) from being seen.

In step 209, the controller 151 deletes those images having such obstructions.

In step 211, the controller 151 stores the remaining images, their product locations and their acquisition time in an image database 155. The process of image acquisition may be run periodically. At least one previous image of each product location may be stored in the image database to be used in the event that an acquired image for the current acquisition time is unacceptable due to an obstruction or cannot show the product location clearly.

In an alternative embodiment, if an image is determined to be unacceptable, the image acquisition subsystem 110 may be directed by the controller 151 to acquire another current image at some later time to be used to replace the deleted image.

FIG. 3 is a flow chart illustrating processing of a customer request in accordance with one aspect of the present invention. This embodiment of the present invention will be described in connection with both the apparatus of FIG. 1 and the flowchart of FIG. 3 indicating the structure and function of the present invention.

The process starts at block 301. A user 3, which is the customer in this example, interacts with a user's computing device 120, causing it to run executable code in step 303 which may be referred to as a program or App.

In step 305, the user 3 interacts with the user's computing device 120 by providing information indicating which product the user 3 would like to find.

In step 305, the user's computing device 120 may provide images or text of the products which relate to the information provided by the user 3. The user 3 may interactively provide different information to which the user's computing device 120 will provide different images and text relating to the new information. Based upon this interactivity, the user 3 selects one of the displayed products.

In an alternative embodiment, information relating to the product may be located in the product database 153 of the retailer's computing device 150. In this embodiment, the user's computing device 120 acts as an intermediate between the user 3 and the retailer's computing device 150. In this embodiment, user 3 provides information on the product that the user would like to find to the user's computing device 120. User's computing device then passes the product information provided by user 3 to the controller 151 of the retailer's computing device 150. The controller 151 does a search of the product database 153 and returns images and text of products relating to the information provided by the user 3 to the user's computing device 120 which is displayed to user 3.

This interactive process may be repeated until the user selects a product.

In step 309, the users computing device 120 sends an indication of the desired product to the controller 151 of the retailer's computing device 150.

In step 311, the controller 151 searches the product database 153 to find the matching product and also acquires a product location that is associated with the product that is returned to the controller 151.

In step 313, the controller uses the product location returned from the product database 153 and uses it as an index into the image database 155. The image database 155 returns at least one image of the product location and its acquisition time to the user's computing device 120 in step 315.

In step 317, the product name, the product location, the image of the product location, and the acquisition time are displayed on the user's computing device 120 to the user 3.

The user 3 then, in step 319 visually verifies that the desired product is available on the shelf, and that the image is recent enough to be accurate. The process finishes at step 321.

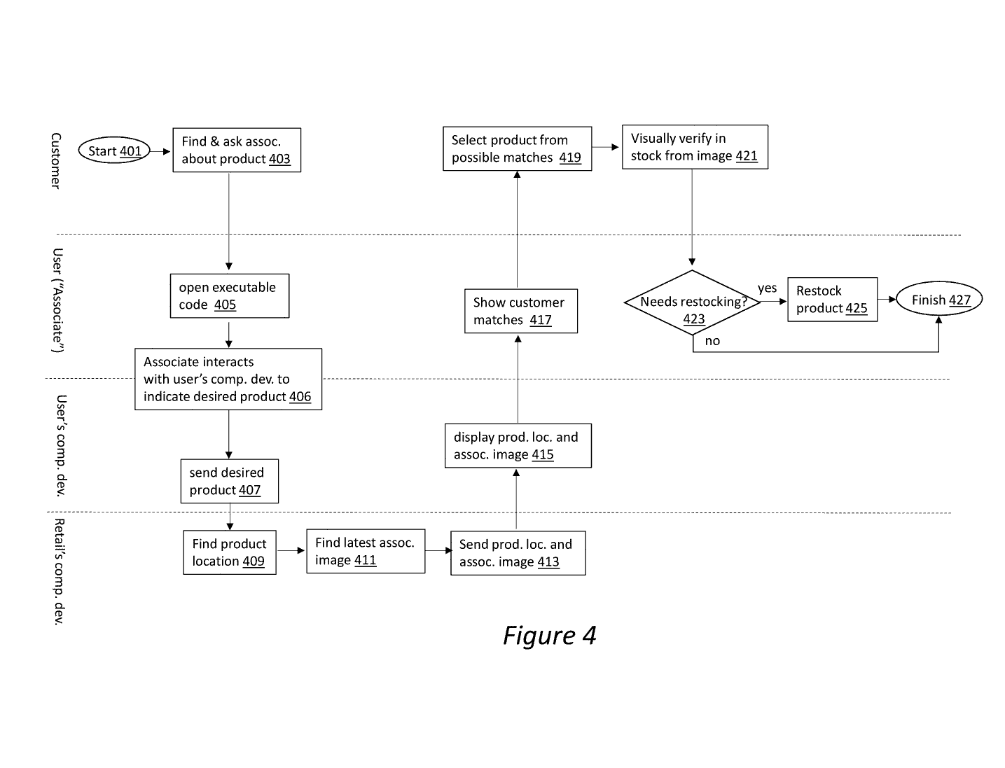

FIG. 4 is a flow chart illustrating how an associate would interact with an embodiment of the present invention to process a customer request. This embodiment of the present invention will be described in connection with both the apparatus of FIG. 1 and the flowchart of FIG. 4 indicating the structure and function of the present invention.

The process starts in block 401. In block 403, the customer finds and asks an associate if a product is in stock and where to find it.

In block 405, the associate is acting as the user 3 and opens the executable code.

In block 406, the associate interacts with the user's computing device 120 to select a desired product in the same manner as described above.

In step 407, the user's computing device 120 sends an indication of the desired product to the controller 151 of the retailer's computing device 150.

In step 409, the controller 151 searches the product database 153 to find the matching product and also acquires a product location that is associated with the product that is returned to the controller 151.

In step 411, the controller 151 receives the product location returned from the product database 153 and uses it as an index into the image database 155. The image database 155 returns at least one image of the product location and its acquisition time to the user's computing device 120 in step 415.

In step 417, the product name, the product location, the image of the product location, and the acquisition time are displayed on the user's computing device 120 to the user 3.

In step 419, the associate shows the customer the display of the user's computing device 120. If more than one product matches the information provided by the customer, then the customer chooses the desired product from the several products and images provided in step 421.

The customer then visually verifies if the product is in stock in step 421.

In step 423, the associate determines if the product location needs to be stocked.

It is determined if this product needs restocking in step 423.

If it does, it is restocked in block 425.

The process finishes in block 427.

Although a few examples have been shown and described, it will be appreciated by those skilled in the art that various changes and modifications might be made without departing from the scope of the invention, as defined in the appended claims.

1. A system for visually determining the presence of products in a retail store, comprising:
a product database adapted for storing information of products having an identification of a plurality of products and their associated product locations;
an image database adapted for storing images of product locations and a time each image was acquired;
a plurality of security camera devices coupled to the image database, capable of acquiring images of product locations, and storing these images, their acquisition time, and their product locations in the image database;
a user's computing device adapted to interact with a user to select a product;
a retailer's computing device coupled to the user's computing device, the product database, and the image database adapted to receive the selected product, find its product location in the product database, acquire the latest acquired image of the product location in the image database and send this information to the user's computing device to be presented to the user.

2. The system of claim 1, wherein the user's computing device is a mobile device.

3. The system of claim 2, wherein the mobile device is a smartphone.

4. The system of claim 1, wherein the retailer's computing device is a server.

5. The system of claim 1, wherein at least one security camera is responsive to the retailer's computing device that causes the at least one security camera device to acquire a current image of a desired product location, when an image of a product location is not acceptable.

6. The system of claim 1, wherein an image is not acceptable if the time stamp indicates that it is older than a predetermined date and time.

7. The system of claim 1 wherein at least one of the security camera devices discards images which are blocked by persons or objects.

8. The system of claim 1 further comprising:
a camera positioning device, adapted to position the at least one security camera to acquire an image of a desired product location.

9. The system of claim 8 wherein the camera position device is responsive to one of the group consisting of: the user's computing device and the retailer's computing device.

10. A method of visually verifying the presence of products available for sale, comprising the steps of:
interacting with a user to select a product;
searching a product database to find a product location corresponding to the selected product;
providing an image database having a plurality of images acquired by security camera devices of product locations time-stamped with the time each image was acquired;
searching the image database to acquire the latest image of the product location of the selected product;
displaying the latest image of the product location of the selected product to the user.

11. The method of claim 10, wherein the step of interacting with a user to select a product comprises the step of:
interacting with a user, using a user's computing device, to select a product.

12. The method of claim 10, wherein the step of searching the image database comprises the step of:
searching the image database, using a retailer's computing device, to acquire the latest image of the product location of the selected product.

13. The method of claim 10, wherein the step of displaying the latest image comprises the step of:
displaying the latest image of the product location of the selected product on the user's computing device to the user.

14. The method of claim 10, wherein the step of providing an image database comprises the steps of:
acquiring a plurality of images of product locations each acquired at a specific acquisition time;
automatically reviewing each image to determine if an obstacle is obstructing a view of the product location in the image;
deleting images in which the product location is blocked by an obstruction;
storing the remaining images with their image locations and their acquisition time in an image database; and
providing access to the image database.

15. A system for remotely identifying product locations to be stocked, comprising:
a database adapted for storing an identification of a plurality of products and their associated product locations, images of product locations each identified by their product location and time of acquisition;
a plurality of security camera devices in the building capable of acquiring images of product locations at specific acquisition times, and storing these images, their product locations, and acquisition times in the database;
a user's computing device adapted to interact with a user to select a product;
a retailer's computing device coupled to the user's computing device, the database adapted to receive the selected product, find its product location in the database, acquire the latest image of the product location in the database and send this product location, and latest image to the user's computing device to be presented to the user.

16. The system of claim 15 wherein the retailer's computing device is coupled to the user's computing device by a communication link.

17. The system of claim 16 wherein the communication link at least partially employs Wi-Fi, cellular, Internet and Bluetooth communication.

18. The system of claim 15 wherein the user's computing device is a mobile device.

19. The system of claim 18 wherein the mobile device is a smartphone.

20. The system of claim 15 wherein the retailer's computing device is a laptop computer.
